(19) United States
(12) Patent Application Publication
(10) Pub. No.: US 2019/0073243 A1
(43) Pub. Date: Mar. 7, 2019

(54) USER-SPACE SPINLOCK EFFICIENCY USING C-STATE AND TURBO BOOST

(71) Applicant: ALIBABA GROUP HOLDING LIMITED, George Town (KY)

(72) Inventor: Xiaowei JIANG, San Mateo, CA (US)

(73) Assignee: ALIBABA GROUP HOLDING LIMITED

(21) Appl. No.: 15/698,568

(22) Filed: Sep. 7, 2017

(51) Int. Cl. G06F 9/50; G06F 1/30; G06F 9/54; G06F 1/32; G06F 9/30

(52) U.S. Cl. CPC G06F 9/5022; G06F 9/5094; G06F 1/305; G06F 9/545; G06F 2209/5018; G06F 1/3296; G06F 9/3009; G06F 9/30083; G06F 1/324

(57) ABSTRACT

Systems and methods for efficiently protecting simultaneous access to user-space shared data by multiple threads using a kernel structure is disclosed. Further, a mechanism within a spinlock allows reduction of the performance and power interference associated with the improved spinlock. This allows a thread in the critical section to complete its execution sooner by increasing the frequency and voltage of the CPU core it runs on. The improved spinlock allows a thread to enter a power saving state and the critical section to instruct a PCU to allocate a headroom power budget exclusively to the core that executed the instruction. The improved spinlock also provides saving in dynamic power during clock gated of the CPU resources and dynamic and static power during power gated of the CPU resources.

### TECHNICAL FIELD

The present application relates to systems and methods for efficiently protecting simultaneous access to user-space shared data by multiple threads using a kernel structure.

### BACKGROUND

While the CPU core count in today's chip-multiprocessors keeps growing, applications are becoming more and more multi-threaded. Although threads in a multi-threaded application are intended to work independently on their each individual tasks, they still share certain amount of data. Shared data access needs to be protected using synchronization primitives; otherwise, these data may be left in an inconsistent state if written simultaneously.

Spinlock is one kind of kernel structure primitive that protects shared data from being simultaneously accessed by multiple threads. In operation, a thread examines whether a lock variable used to lock the critical section of a thread's operation on shared data is available. When the lock variable is enabled, it protects the shared data from being simultaneously acquired by multiple threads to perform their task. This is critical, since if more than one thread is allowed access to a same shared data, the shared data will become unstable. If the lock variable is free, i.e., not being used by another thread, the thread looking for the availability of the lock variable can acquire it before entering the critical section. If, on the other hand, the lock variable is not free, for example, when the lock variable has been acquired by another thread, the thread looking to acquire the lock variable “spins” on the lock until it becomes available. For example, the thread waits for its turn.

Because spinlocks avoid overhead from operating system process rescheduling or context switching, spinlocks are efficient if threads are likely to be blocked for only short periods. However, spinlocks become wasteful if held for longer durations, as they may prevent other threads from running and require rescheduling. The longer a thread holds a lock, the greater the risk that the thread will be interrupted by the OS scheduler while holding the lock. If this happens, other threads will be left “spinning” (repeatedly trying to acquire the lock), while the thread holding the lock is not making progress towards releasing it. The result is an indefinite postponement until the thread holding the lock can finish and release it. This is especially true on a single-processor system, where each waiting thread of the same priority is likely to waste its quantum (allocated time where a thread can run) spinning until the thread that holds the lock is finally finished.

This problem is also seen in current multiprocessors, where the CPU core count keeps growing, and the applications are becoming more and more multithreaded. Although threads in a multithreaded application intend to work independently on their each individual task, there is still a certain amount of shared data. Shared data access needs to be protected using spinlock and the like, or the shared data may be left in an inconsistent state if written on simultaneously. Even though current applications are multithreaded, access to the critical section from all threads is still a serialized effort, which has amplified the “busy waiting” period.

As shown above, conventional spinlocks may not be advantageous for system-wise throughput. If the system runs many tasks, threads in one task may unnecessarily occupy the CPU while making no progress. The alternative to conventional spinlock is, for example, mutex. Instead of occupying the CPU to keep retrying the lock acquisition, threads that fail to acquire the lock simply yield the CPU to other tasks. While eliminating the period that produces no useful work, mutex has significant performance costs to the threads that yield the CPU. This is because yielding the CPU as well as getting rescheduled back to reacquire the lock, need to invoke the OS scheduler to perform expensive context switches. Moreover, mutex is a synchronization primitive that is only available in the OS kernel. Since it requires active invocation to the OS scheduler, mutex cannot be used in user-space.

### SUMMARY

Embodiments of the present disclosure provide a processing system and a method of efficiently protecting simultaneous access to user-space shared data by multiple threads using a kernel structure such as an improved user-space spinlock.

Embodiments of the present disclosure also provide a processing system and a method of accessing, by a memory, shared data of a user-space to a plurality of threads of an application and executing, by a plurality of cores, one or more threads of the plurality of threads, wherein a core of the plurality of cores is configured to acquiring a lock, by a thread, to indicate a processing of the shared data, and generating a notification that the core has acquired the lock, wherein the notification instructing one or more other threads attempting to access the shared data to enter a power saving state, wherein the power saving state is a selected C-State.

Embodiments of the present disclosure also provide indication, by the acquisition of the lock, that the thread will be entering or has entered in a critical section. The processing system and method further comprising a power control unit configured to allocating additional power to the core based on the thread entering in a critical section. The power control unit further configured to determining an appropriate P-State for each of the cores in the plurality of cores and in detecting a reduction in power of the plurality of cores having threads that have entered the power saving state. The power control unit still further configured to increasing voltage and frequency of the core having the thread that has entered in the critical section.

Embodiments of the present disclosure also provide monitoring, by the one or more other threads that have entered the power saving state, whether the lock has been released, wherein the monitoring is based on one or more observations of a memory location of the core that includes the thread that has acquired the lock, and determining, by the one or more other threads, that the lock has been released and attempting to acquire a lock to the shared data by at least one thread of the one or more other threads.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 is a block diagram using an exemplary x86 assembly language pseudo code to implement a conventional spinlock.

FIG. 2 is a block diagram illustrating an exemplary performance cost associated with a conventional spinlock.

FIG. 3 is a schematic illustration of an exemplary processing system, consistent with the disclosed embodiments of the present disclosure.

FIG. 4 is a block diagram illustrating an exemplary working mechanism of the improved spinlock in a user-space, consistent with embodiments of the present disclosure.

FIG. 5 is a flowchart representing an exemplary method of the performance cost associated with the improved spinlock in a user-space, consistent with embodiments of the present disclosure.

FIG. 6 is a block diagram using an exemplary x86 assembly language pseudo code to implement the improved spinlock in a user-space, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The disclosed embodiments provide an improved spinlock that can achieve high performance when accessing critical sections in user-space. The improved user-space spinlock can be used in high speed frameworks to achieve low latency and high bandwidth. For example, today's high performance server systems are often equipped with high speed Solid State drives (SSDs) and SmartNlCs, which provide high bandwidth and low latency I/O. The disclosed embodiments can use dedicated user-space threads to replace OS kernel code to access these high speed devices, such as Data Plane Development Kit Storage (DPDK) and Storage Performance Development Kit (SPDK). Moreover, the improved user-space spin lock can be also crucial to the performance of multithreaded applications that have extensive shared data access, such as the Relational Database Management System (RMDBS).

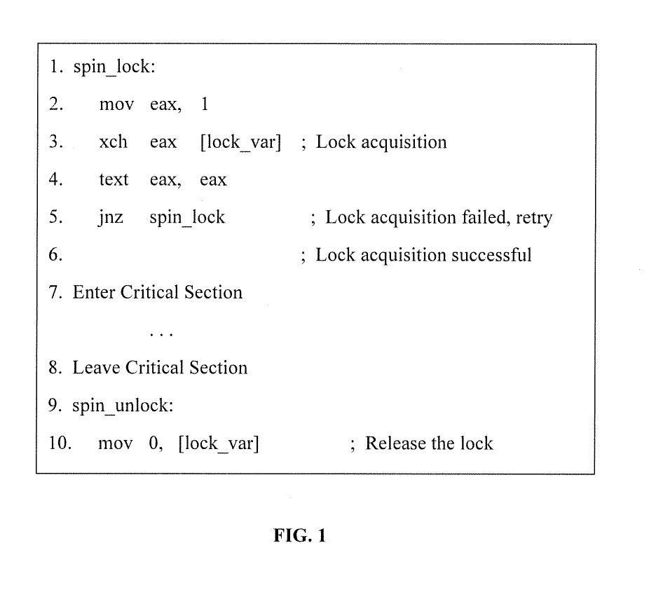

A conventional spinlock is a kernel structure primitive that protects shared data from being simultaneously accessed by multiple threads. Reference is now made to FIG. 1, which is a block diagram using an exemplary x86 assembly language pseudo code to implement a conventional spinlock. Code in a thread's body that accesses shared data is called critical section. Each critical section is typically protected with a lock variable, for example lock_var, which is exclusively granted to one thread at any given time. As such, threads need to compete to acquire the lock before they can enter the critical section. Threads that failed to acquire the lock will keep trying the lock acquisition until it succeeds. In other words, the holder of the lock releases the lock after it finishes executing its critical section. Since the thread remains active but is not performing a useful task, the use of such a lock is busy waiting. During this busy waiting period, the thread produces no useful work, yet completely occupies the CPU and consumes copious amounts of energy. Once acquired, spinlocks will usually be held until they are explicitly released, although in some implementations they may be automatically released if the thread being waited on (that which holds the lock) blocks, or goes to sleep.

Returning to FIG. 1, the actual instruction that performs lock acquisition (xch, in line 3) is an atomic instruction provided by the underlying CPU instruction set. An atomic instruction ensures atomicity of the instruction execution, which either completes the entire bundle of the instruction, or fails otherwise. Atomic instructions are typically implemented to lock the entire cache and memory bus accessed, and declines everything else from reading from or writing to it. This has made the execution of atomic instructions fairly expensive. In the code snippet shown in FIG. 1, the code used to spin relies on the atomic instruction, which makes the performance of the spin unacceptable.

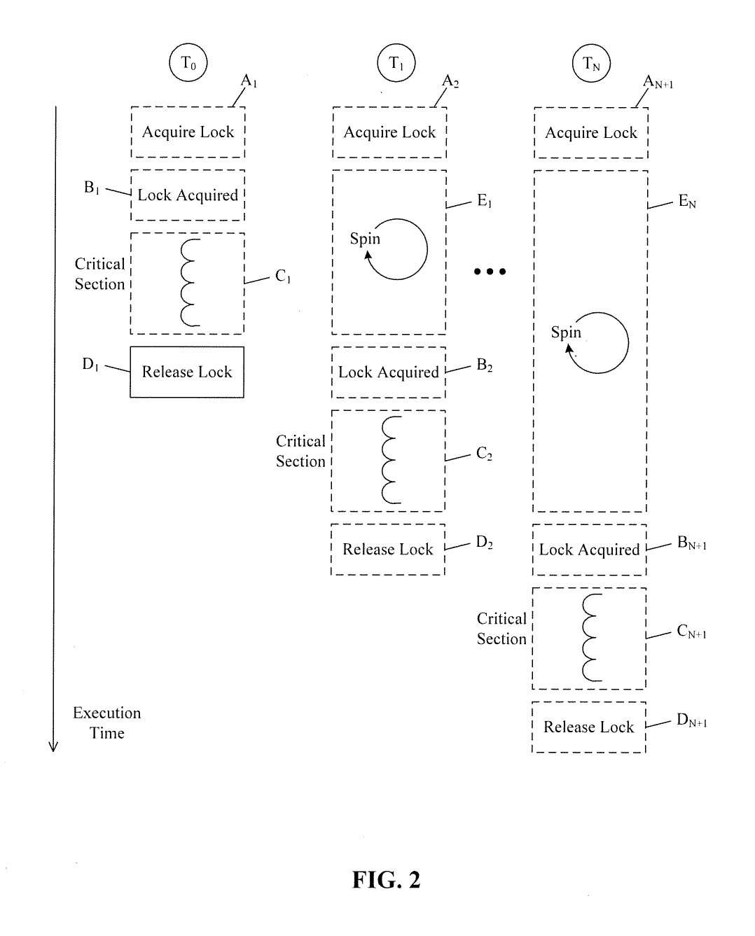

Reference is now made to FIG. 2, which is a block diagram illustrating an exemplary performance cost associated with a conventional spinlock. The performance cost shown in FIG. 2 is illustrative, in that the acquisition of the lock is sequentially shown to be acquired by threads T₀-T_{N}. In operation though, this sequential acquisition is not always the case. Threads T₀-T_{N} could acquire the lock in any random order. In the case of N threads competing for the lock, it is guaranteed that N-1 threads would fail in the first round. Therefore, they all have to wait for the thread that has successfully acquired the lock. When the thread that holds the lock finishes its critical section and releases the lock, the other N-1 threads will again compete for the lock, and N-2 threads would fail and thus spin on the lock. As a result, the amount of spin is always O(N²) of the length of the critical section, where O describes the order of complexity or limiting behavior of a function when the arguments tend towards a particular value or infinity.

In operation, the code used to spin is usually implemented using industry standards such as test and set that rely on regular read instructions to fetch the lock variable, or test and test and set that first fetch the lock variable using regular read instructions, and spin on a while loop for a certain amount of time before reissuing the read. However, even with such optimizations, the CPU is still completely occupied by the threads that spin, producing no useful amount of work while expending energy. In addition, because the threads that spin need to continuously issue reads to the lock variable stored in memory, they may interfere with the execution of the thread that runs in critical section.

Returning to FIG. 2, thread T₀ attempts to acquire the lock at A₁ and is successful at B₁. At the same time, threads T₁-T_{N} continue to attempt acquire the lock at A₂-A_{N+1}. Since thread T₀ is successful at B₁, threads T₁T_{N} spin at E₁-E_{N}, i.e., wait for thread T₀ to complete its task. Threads T₁-T_{N} spin until thread T₀ is in critical section C₁. When thread T₀ completes its task and releases the lock at D₁, threads T₁-T_{N} retry to acquire the lock; thread T₁ is successful at B₂ at this retry, but threads T₂ (not shown)-T_{N} continue to spin at E₂ (not shown)-E_{N} until thread T₁ is in critical section C₂.

When thread T₁ releases the lock at D₂, threads T₂ (not shown)-T_{N} retry to acquire the lock and the process continues, until thread T_{N} acquires the lock at B_{N+1}, enters critical section at C_{N+1}, and releases the lock at D_{N+1}. From this illustration, the total time it takes for thread T_{N} to acquire the lock, enter critical section, and release the lock, is exponentially more than the time it takes for thread T₀ to acquire the lock, enter critical section, and release the lock. As a result, the amount of spin is always O(N²) of the length of the critical section. Since thread T_{N} spins for the longest amount of time (length of E_{N} is more than length of any preceding spin blocks), the overall throughput is directly dependent on the number of threads acquiring the lock and the amount of time each thread has to spend spinning.

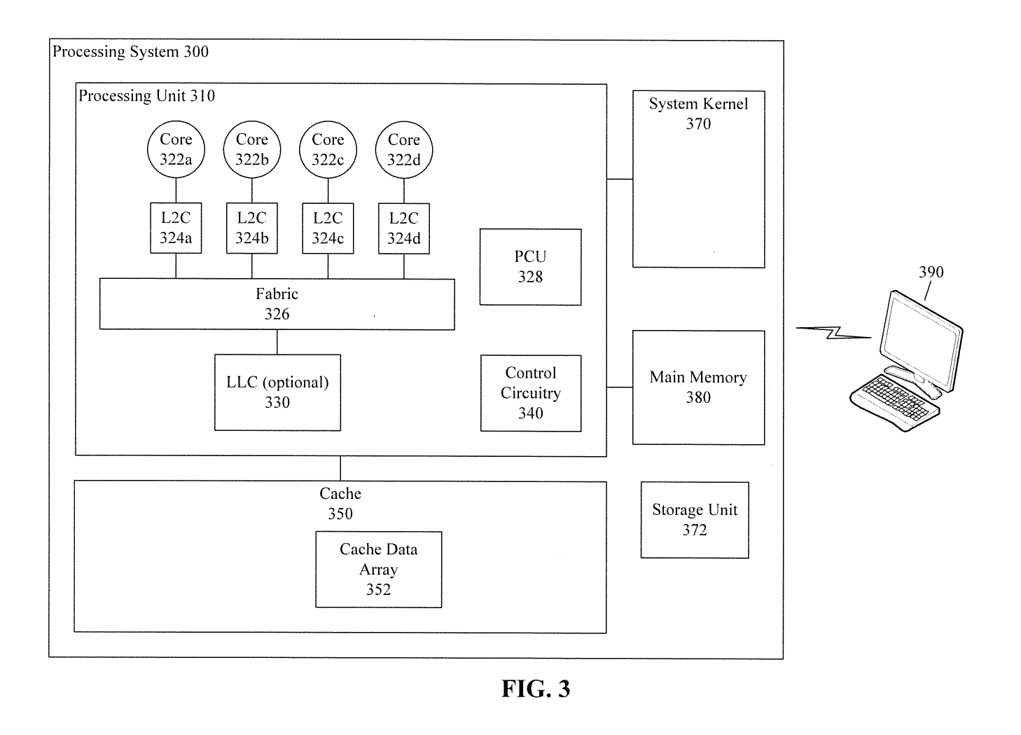

FIG. 3 is a schematic illustration of an exemplary processing system 300, consistent with the disclosed embodiments. Processing system 300 can be included in a cloud-based server of a service provider. The server can be accessed by a user device 390 via a network. As shown in FIG. 3, processing system 300 includes a processing unit 310, and a cache 350, a system kernel 370, and a main memory 380 coupled to processing unit 310. Main memory 380 can store data to be accessed by processing unit 310. System kernel 370 can control the operation of processing system 300. Processing system 300 includes a system kernel 370 and a storage unit 372 that stores a task struct data structure that describes attributes of one or more tasks/threads to be executed on processing system 300.

Processing unit 310 and cache 350 can be included in a CPU chip in which processing unit 310 is disposed on a CPU die and cache 350 is disposed on a die physically separated from the CPU die. Processing unit 310 includes a plurality of processing cores 322a-b, a plurality of Level-2 caches (L2Cs) 324a-d respectively corresponding to and coupled to the plurality of processing cores 322a-d and coupled to a fabric 326. In addition, processing unit 310 includes a power control unit (PCU) 328, a Last-level cache (LLC) 330 (which may be optional), and control circuitry 340. Cache 350 includes a cache data array 352.

PCU 328 runs power algorithms in its firmware to determine an appropriate P-State for each core 322a-d. P-States have predefined frequencies and voltage points for each of the power islands in the processing unit 310. In general, a higher voltage will be associated with higher frequency, and thus results in high power consumption.

Today's CPUs typically define several CPU power states, also known as C-States, such as C₀-C₆ defined in Intel®'s x86. When the CPU core runs at normal, it is in the C₀ state with all CPU resources operational. When it enters a deeper C-State, part of its resources are either clock gated or power gated. For instance, at C₁-State, the CPU core's clock is gated resulting in the core in a halt state, while the L2 cache is still fully operational.

When clock gated, the input clock to the part being clock gated is stopped, thus no logic toggling can occur, which saves dynamic power. When power gated, the power input to the power island the part resides on is switched off, thus making the entire part in power off state and saving both dynamic and static power. Power gating essentially loses the current states stored in the CPU part, and requires some critical states to be saved in retention flops, or flushed to memory before switching off the power.

The performance impact of clock gating, for example C₁-State in x86 is negligible, as stopping and granting clock have almost zero delay. However, clock gating does not save much power compared to power gating. This does not leave much head room to Turbo Boost the core in a critical section. On the other hand, the performance impact of power gating, for example C₂-State-C₇-State in x86 is substantial. On average, the latency to transit from C₂-State to normal C₀-State in latest x86 CPUs is around 1 μs, and from C₆-State back to C₀-State can be tens of μs.

Embodiments of the present disclosure also provide mechanisms within the improved user-space spinlock (or improved spinlock) to reduce the performance and power interference associated with spinlock implementation. Embodiments of the present disclosure also provide an ability of a thread in the critical section to complete its execution sooner by increasing the frequency and voltage of the CPU core it runs on.

According to embodiments of the improved spinlock in a user-space, the improved spinlock is also provided as a library function. In particular, multiple such library APIs are provided, with each API allowing the entering of one particular C-State, for instance, spinlock_C₁, spinlock_C₂, and so on. In practice, programmers can enable selection of which user-space spinlock to use. According to further embodiments, a longer critical section, for example, a user-space spinlock API with deeper C-State is used. This is because lengthy critical sections can amortize the delay of C-State transition back to C₂-State easily.

According to embodiments, a mechanism is provided within the improved spinlock to reduce the performance and power interference associated with the spinlock implementation. According to further embodiments, the frequency and voltage of the CPU core is increased to provide an ability for a thread in the critical section to complete its execution sooner. In particular, embodiments leverage the C-State and Turbo Boost technologies provided by the CPU. According to still further embodiments, a savings in dynamic power is provided during clock gated of the CPU resources. According to still further embodiments, a savings in dynamic and static powers is provided during the power gating of the CPU resources.

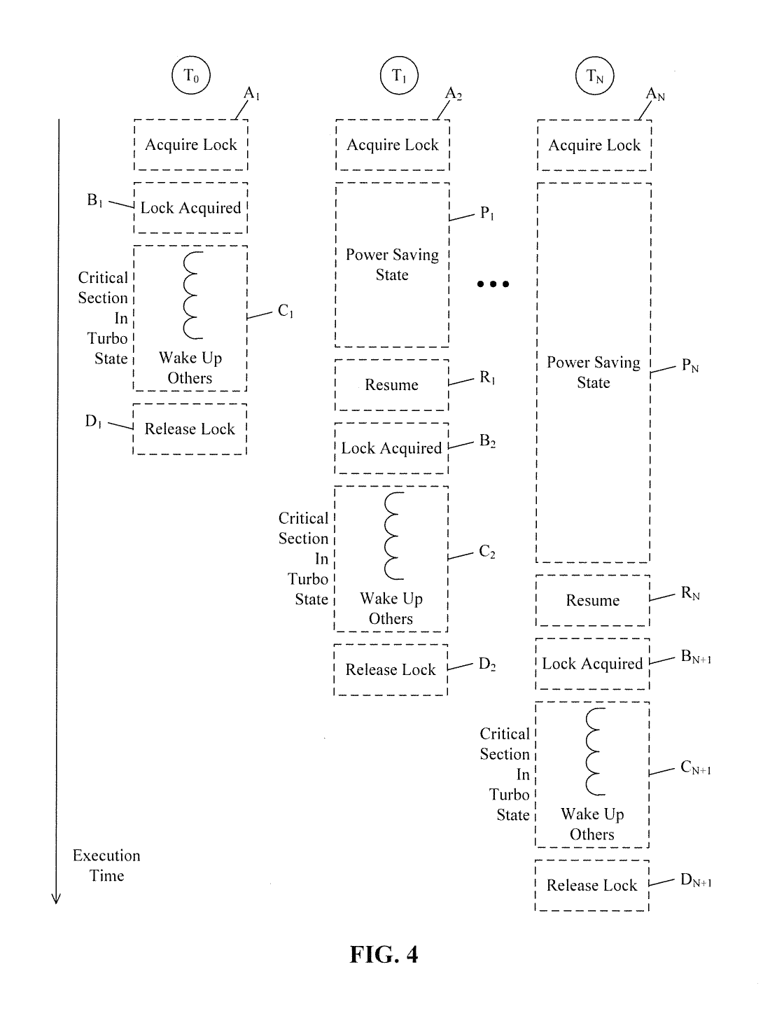

Embodiments of the present disclosure also provide new instructions within the improved spinlock to allow a thread, for example thread T₁ in FIG. 4 to enter a power saving state in the user-space and to allow the thread in the critical section, for example thread T₀ in FIG. 4 to instruct a Power Control unit (PCU) in the CPU to allocate a headroom power budget exclusively to the core that executed the instruction.

Embodiments of the present disclosure also provide saving dynamic power during clock gated of the CPU resources. Embodiments of the present disclosure also provide saving dynamic and static power during power gated of the CPU resources. Embodiments of the present disclosure also provide the improved spinlock as a library function.

Reference is now made to FIG. 4, which is a block diagram illustrating an exemplary working mechanism of the improved spinlock in a user-space, consistent with embodiments of the present disclosure. Critical sections are still protected using lock variables, and threads need to compete to acquire the lock before entering the critical section in order to access shared data. After failing to acquire the lock, instead of spinning on the lock, all remaining threads enter a low-power CPU state to save power. Multiple CPU cores entering a low-power state essentially reduce the effective power consumption of the entire CPU package, which in turn creates headroom that enables the currently running core to enter a higher P-State (or Turbo Boost) by increasing the input voltage of the running core. As a result, the thread in the critical section can potentially complete sooner. Before the thread completes its work and is about to leave the critical section, it is responsible to wake up the other threads who are currently in power saving states. Once awoken, these threads will continue to retry competing for the lock acquisition.

Returning to FIG. 4, thread T₀ tries to acquire the lock at A₁ and is successful at B₁. At the same time, threads T₁-T_{N} are also trying to acquire the lock at A₂-A_{N+1}. Since thread T₀ is successful, at B₁, threads T₁-T_{N} enter a power saving state P₁-P_{N}, where they wait for thread T₀ to complete its task. During the power saving states P₁-P_{N}, the PCU detects the CPU cores that have reduced their power as a result of failed threads, which are in a deeper C-State. Now there is headroom available in the overall CPU package power. This allows the PCU to increase the voltage and frequency of the running CPU core. As a result, the thread (T₁) that runs in the critical section can complete sooner.

Returning to FIG. 4, threads T₁-T_{N} remain in a power saving state P₁-P_{N} until thread T₀ is in critical section C₁. When thread T₀ completes its task, thread T₀ wakes up the other waiting threads T₁-T_{N} before releasing the lock at D₁. Threads T₁-T_{N} retry to acquire the lock at R₁-R_{N}, respectively. Thread T₁ is successful at B₂ at this retry, but threads T₂ (not shown)-T_{N} continue to stay in the power saving state, P₂ (not shown)-P_{N} until thread T₁ is in critical section C₂. When thread T₁ completes its task, thread T₁ wakes up the other waiting threads T₂(not shown)-T_{N} before releasing the lock at D₂. Threads T₂(not shown)-T_{N} continue the process, until thread T_{N} acquires the lock at B_{N+1}, enters critical section at C_{N+1} and releases the lock at D_{N+1}. From this illustration, the total time it takes for thread T_{N} to acquire the lock, enter critical section, and release the lock, is much less than the total time it takes for thread T_{N} to acquire the lock, enter critical section, and release the lock, as illustrated in FIG. 2.

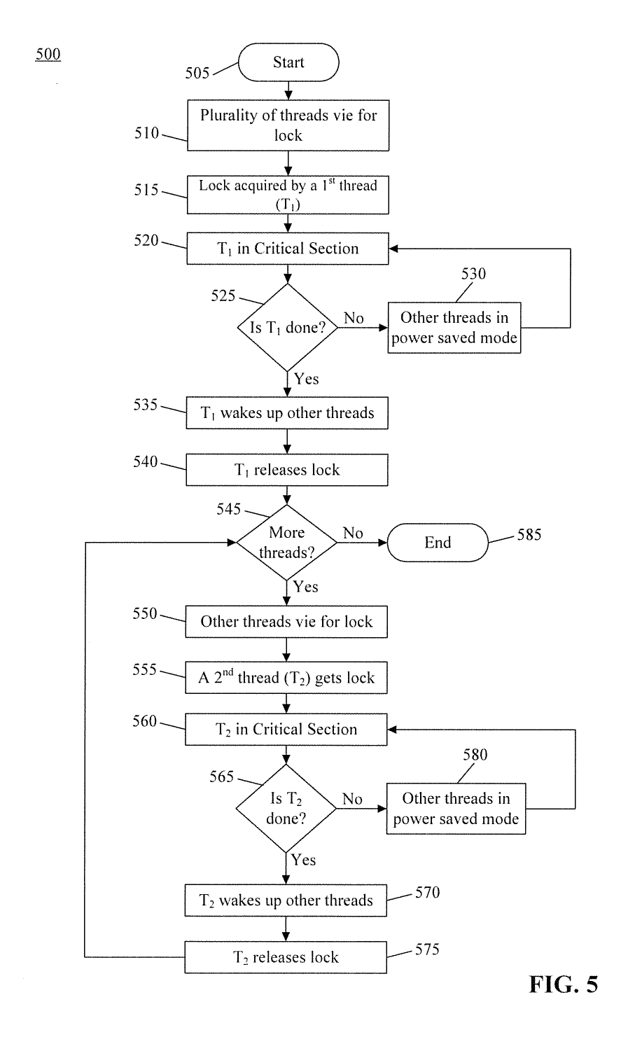

Referenced is now made to FIG. 5, which is a flowchart representing an exemplary method 500 of the performance cost associated with the improved spinlock in a user-space, consistent with embodiments of the present disclosure. Referring to FIG. 5, it will readily be appreciated that the illustrated procedure can be altered to delete steps or further include additional steps, as described below. Moreover, steps can be performed in a different order than shown in method 500, and/or in parallel. While the flowchart representing method 500 provides exemplary steps for a processor (e.g., an x86 Intel® processor) to implement an improved spinlock in a user-space, it is appreciated that one or more other processors from other manufacturers can perform substantially similar steps alone or in combination on a client end-device (e.g., a laptop or cellular device) or backend server.

After initial start step 505, one or more threads (e.g., threads T₁-T_{N} of FIG. 4) vie for the lock at step 510. Next, at step 515 a first thread (e.g., thread T₀ of FIG. 4) acquires the lock (e.g., at block A₁ of FIG. 4). As discussed, the thread that acquires the lock (e.g., at block B₁ of FIG. 4), enters the critical section, e.g., at step 520 (and block C₁ of FIG. 4) before it executes its task. Next, at step 525 a check is made if the thread in the critical section (e.g., the first thread T₀) has completed its task. If the first thread is still in the critical section (the “no” branch from step 525), at step 530 the other waiting threads enter a power saving state (e.g., at blocks P₁-P_{N} of FIG. 4) and the flow continues back to step 520.

If, on the other hand the first thread has finished its task (the “yes” branch from step 525), at step 535 the first thread wakes up the other waiting threads (e.g., at block C₁ of FIG. 4) before releasing the lock at step 540 (e.g., at block D₁ of FIG. 4) so that one of the other waiting threads can acquire it (e.g., at blocks A₂-A_{N} of FIG. 4). Next, at step 545 another check is made if there are other waiting threads. If there are other waiting threads (the “yes” branch from step 545), at step 550 the other threads vie for the lock. Next, at step 555 a second thread (e.g., thread T₁ from FIG. 4) acquires the lock (e.g., at block B₂ of FIG. 4) and enters, at step 560, the critical section (e.g., at block C₂ of FIG. 4).

Next, at step 565, yet another check is made if the thread in the critical section has completed its task, e.g., T₁. If the second thread is still in critical section (the “no” branch from step 565), at step 580 the other waiting threads continue to remain in the power saving state, e.g., at blocks P₂ (not shown)-P_{N} of FIG. 4 and the flow continues back to step 560. If, on the other hand the second thread has finished its task (the “yes” branch from step 565), at step 570 the second thread wakes up the other waiting threads (e.g., at block C₂ of FIG. 4), before releasing the lock at step 575 (e.g., at block D₂ of FIG. 4), so that one of the other threads can acquire it (e.g., at blocks A₃(not shown)-A_{N} of FIG. 4) and the flow goes back to step 545. If, at step 545 there are no more waiting threads, the method ends at step 585.

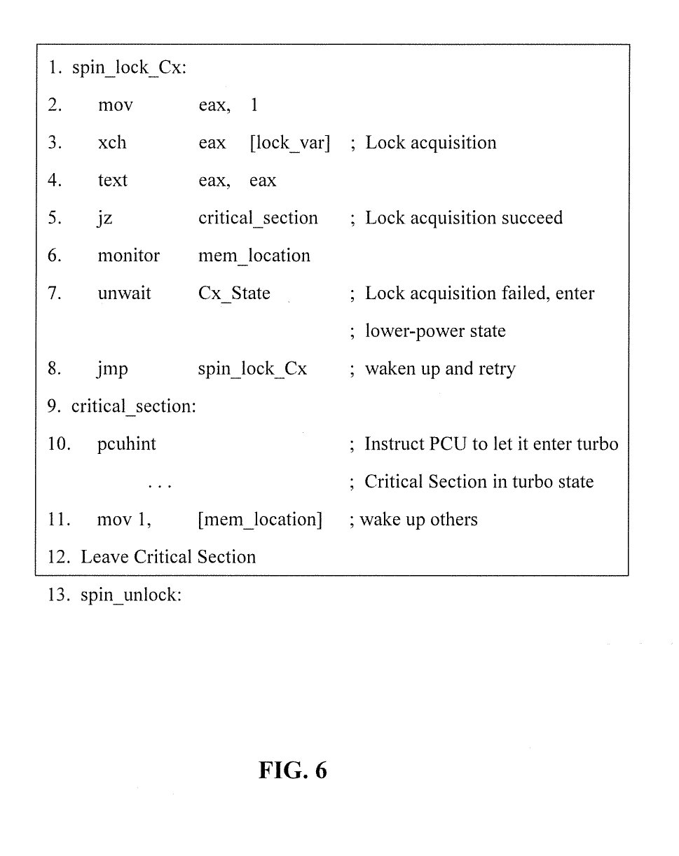

Reference is now made to FIG. 6, which is a block diagram using an exemplary x86 assembly language pseudo code to implement the improved spinlock in a user-space, consistent with embodiments of the present disclosure. According to embodiments, at least two new instructions are included, for example an umwait instruction to allow a thread to enter a power saving state in the user-space, and a pcuhint instruction to allow the thread in the critical section to instruct the PCU in the CPU to allocate headroom power budget exclusively to the core executing the pcuhint instruction.

Returning to FIG. 6, the threads still use an atomic instruction to acquire the lock. Once failed, for example, at line 6, the threads first execute a monitor instruction to setup a memory location to watch, and then executes an umwait instruction, for example at line 7, to enter a selected C-State. It should be noted here that in conventional CPUs, entering power saving states is only available in the OS kernel through privileged instructions. To allow a conventional spinlock in the user-space to enter C-State, the new umwait instruction is required. In operation, the umwait instruction operates similarly to the existing mwait instruction, in that it takes arguments stored in accumulators and counters, for example, EAX and ECX registers in x86 to determine the desired C-State to enter, and stores the returned error code back in ECX. But the difference between the existing mwait instruction and the new umwait instruction ends here. The new umwait instruction allows the thread to be executed when the CPU is in unprivileged mode, for example Intel®'s ring 3, and thus do not raise General Protection (GP) fault when being executed in ring 3.

In operation, when the umwait instruction is executed, the thread that fails to acquire the lock stops executing any instruction and enters the desired C-State. This prevents the failed threads from burning power, eliminating power interference to the running core in the critical section. It also prevents the failed threads from issuing reads to the lock variable, eliminating performance interference to the running core in the critical section.

Returning to FIG. 6, a new pcuhint instruction, for example at line 10, allows the thread running in critical section to communicate with the PCU. Once executed, PCU will allocate all leftover power budget to the core that has executed pcuhint, thereby increasing the core's frequency. Without pcuhint, as in conventional spinlocks, PCU may equally distribute power budget to all currently running cores. Since there could be cores that are running irrelevant tasks, the core running the critical section would potentially get a lesser power boost without pcuhint. It is worth noting that pcuhint takes no operands and can be hence executed in unprivileged mode.

Before the thread in the critical section is about to leave the critical section, it in addition executes a store instruction, for example at line 11 to the memory location being monitored by threads in C-States. Accordingly, these threads will wake up, transit back to C₀-State, and pick up the next instruction, for example at line 8 before entering the C-State to resume execution. As such, these threads will jump back to the beginning of the code snippet illustrated in FIG. 6 to retry the lock.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

1. A processing system comprising:
a memory configured to provide access to shared data of a user-space to a plurality of threads of an application;
a plurality of cores each configured to execute one or more threads of the plurality of threads, wherein a core of the plurality of cores is configured to:
include a thread that acquires a lock indicating a processing of the shared data, and
generate a notification that the core has acquired the lock, wherein the notification instructs one or more other threads attempting to access the shared data to enter a power saving state.

2. The processing system of claim 1, wherein the acquisition of the lock further indicates that the thread will be entering or has entered in a critical section.

3. The processing system of any one of claim 1, further comprising a power control unit configured to allocate additional power budget to the core based on the thread entering in a critical section.

4. The processing system of claim 3, wherein the power control unit is further configured to determine an appropriate P-State for each of the cores in the plurality of cores.

5. The processing system of claim 3, wherein the power control unit is further configured to detect a reduction in power of the plurality of cores having threads that have entered the power saving state.

6. The processing system of claim 3, wherein the power control unit is further configured to increase voltage and frequency of the core having the thread that has entered in the critical section.

7. The processing system of claim 1, wherein the one or more other threads that have entered the power saving state monitor whether the lock has been released.

8. The processing system of claim 7, wherein the one or more other threads monitor whether the lock has been released based on one or more observations of a memory location of the core that includes the thread that has acquired the lock.

9. The processing system of claim 7, wherein if the one or more other threads determine that the lock has been released, at least one thread of the one or more other threads attempts to acquire a lock to the shared data.

10. The processing system of claim 1, wherein the power saving state is a selected C-State.

11. A computer-implemented method executed on a processing system having a memory and a plurality of cores, comprising:
providing access to shared data of a user-space to a plurality of threads of an application;
executing, by the plurality of cores, one or more threads of the plurality of threads;
acquiring, by a core of the plurality of cores, a lock by a thread in the core indicating a processing of the shared data in user-space, and
generating, by the core of the plurality of cores, a notification that the core has acquired the lock, wherein the notification instructing one or more threads attempting to access the shared data in user-space to enter a power saving state.

12. The method of claim 11 further comprising indicating, when the lock acquisition occurs, that the thread will be entering or has entered in a critical section.

13. The method of claim 11 further comprising allocating, by a power control unit, additional power budget to the core based on the thread entering in a critical section.

14. The method of claim 13 further comprising determining, by the power control unit, an appropriate P-State for each of the cores in the plurality of cores.

15. The method of claim 13 further comprising detecting, by the power control unit, a reduction in power of the plurality of cores having threads that have entered the power saving state.

16. The method of claim 13 further comprising increasing, by the power control unit, voltage and frequency of the core having the thread that has entered in the critical section.

17. The method of claim 11 further comprising monitoring, by the one or more other threads that have entered the power saving state, whether the lock has been released.

18. The method of claim 17 further comprising monitoring, by the one or more other threads, whether the lock has been released based on one or more observations of a memory location of the core that includes the thread that has acquired the lock.

19. The method of claim 17 further comprising determining, by the one or more other threads, if the lock has been released, whereby at least one thread of the one or more other threads attempts to acquiring a lock to the shared data.

20. The method of claim 11 further comprising allocating a selected C-State for the power saving state.

21. A method for managing access to shared data of a user-space, comprising:
determining, by a core of a processing unit, that a lock is acquired by a thread in the core indicating a processing of the shared data in user-space, and
generating, by the core, a notification that the core has acquired the lock, wherein the notification instructing one or more threads attempting to access the shared data in user-space to enter a power saving state.

22. The method of claim 21, further comprising:
allocating, by a power control unit, additional power budget to the core based on the thread entering in a critical section.
